(19) United States
(12) Patent Application Publication
(10) Pub. No.: US 2009/0110437 A1
(43) Pub. Date: Apr. 30, 2009

(54) DUPLEX DOCUMENT FEEDER

(76) Inventors: Min-Hsi Liu, Hsinchu (TW); Wei-Yuan Peng, Hsinchu (TW); Wei-Fong Lin, Hsinchu (TW)

Correspondence Address: BIRCH STEWART KOLASCH & BIRCH, PO BOX 747, FALLS CHURCH, VA, 22040-0747, US

(21) Appl. No.: 11/924,373

(22) Filed: Oct. 25, 2007

(51) Int. Cl. G03G 21/00

(52) U.S. Cl. 399/151

(57) ABSTRACT

A duplex document feeder defines a feeding path. A charging means, a guiding plate equipped with elastic force and a feeding means are located along the feeding path. A driver means provides drive source to the charging means and the inverting means. The guiding plate blocks up the feeding path while the feeding path is empty. The charging means charges a document into the feeding path. The guiding plate is pressed out of the feeding path by the document conveyed via the charging means. Therefore, the document may be conveyed through the feeding path. While the document is conveyed to the feeding means, the guiding plate returns to block up the feeding path via elastic force thereof.

### BACKGROUND OF TEE INVENTION

1. Field of the Invention

The invention relates to a document feeder, especially a duplex document feeder capable of inverting documents and feeding the documents to an image processing machine for dealing with both surfaces of the documents.

2. The Related Art

According to the progress of the image processing technology, many image processing machines are popularly used, such as printers, scanners, fax machines, copy machines, etc. A duplex document feeder capable of inverting documents is developed for cooperating with image processing machines described above for processing both surfaces of the documents.

A conventional duplex document feeder 900 is shown in FIG. 9. The duplex document feeder 900 cooperates with an image processing machine (not shown in figures) and has a plate 901, a driver 902, a gear module 903, a charging module 904, an inverting module 905 and a feeding module 906.

Please refer to FIG. 10 and FIG. 11. The driver 902 has a first driving gear 9020, a driving arm 9021 and a second driving gear 9022. The driving arm 9021 has at least one elastic piece 9023 projected outwardly. The driving arm 9021 is configured between the first driving gear 9020 and the second driving gear 9022. The elastic piece 9023 of the driving arm 9021 presses against the first driving gear 9020. One side of the plate 901 connects the driving arm 9021 of the driver 902.

Please refer to FIG. 12. The driving arm 9021 of the driver 902 and the plate 901 is arranged to face the feeding module 906. So, a sheet (not shown in figures) may be charged into the conventional duplex document feeder 900 by the charging module 904 and conveyed through the plate 901 and then discharged from the conventional duplex document feeder 900 by the feeding module 906 for dealing with one surface of the sheet.

Please refer to FIG. 13. The first driving gear 9020 rotates in clockwise direction to raise the driving arm 9021 via that the first driving gear 9020 rotates against the driving arm 9021. Therefore, the plate 901 is raised by the driving arm 9021 of the driver 902. The sheet is conveyed to the inverting module 905 by the feeding module 906 for being inverted. The sheet is conveyed to the feeding module 906 by the inverting module 905 and discharged from the conventional duplex document feeder 900 by the feeding module 906 for dealing with the other surface of the sheet.

The structure and operation of the conventional duplex document feeder 900 is complex. In is must to tune the friction between the elastic piece 9023 and the first driving gear 9020 for raising and putting down the plate 901 in the predetermined position. The conventional duplex document feeder 900 works incorrectly if the friction between the elastic piece 9023 and the first driving gear 9020 is abnormal.

### SUMMARY OF THE INVENTION

An object of the present invention is to provide a duplex document feeder has simple structure for guiding a sheet to pass through the feeding path and the sheet inverting path for dealing with both surfaces of the sheet.

According to the present invention, the duplex document defines a feeding path and a sheet inverting path and has a frame with a bottom plate, a charging means, a feeding means, a sheet inverting means, a driving means and a guiding plate with elastic force. The charging means, the guiding plate and the feeding means are located along the feeding path. The feeding means and the sheet inverting means are located along the sheet inverting path.

The guiding plate blocks up the feeding path while the feeding path is empty. The charging means conveys a sheet into the feeding path and to press the guiding plate to leave from the feeding path. Therefore, the sheet may be conveyed through the feeding path and to the feeding means. The sheet is conveyed to an image processing machine by the feeding means for dealing with one surface of the sheet.

While the sheet is conveyed into the sheet inverting path, the guiding plate returns to block up the feeding path by elastic force thereof. So, the sheet may be conveyed through the sheet inverted path and to the image processing machine again for dealing with the other surface of the sheet. Therefore, the duplex document has a simple structure for guiding the sheet to pass through the feeding path and the sheet inverting path for dealing with both surfaces of the sheet.

### BRIEF DESCRIPTION OF THE DRAWINGS

The present invention will be apparent to those skilled in the art by reading the following description of a preferred embodiment thereof, with reference to the attached drawings, in which:

FIG. 1 shows a top view of a duplex document feeder according to the present invention;

FIG, 2 shows a bottom view of the duplex document feeder according to the present invention;

FIG. 3 is a cross section showing a part of a bottom plate of a frame of the duplex document feeder according to the present invention;

FIG. 4 is a cross section of the bottom plate of the frame of the duplex document feeder according to the present invention;

FIG. 5 shows a guiding plate of the duplex document feeder according to the present invention;

FIG. 6 is a cross section showing cooperation of the bottom plate of the frame and the guiding plate of the duplex document feeder according to the present invention;

FIG. 7 is a cross section showing the part XIV in FIG. 6;

FIG. 8 shows operation of the duplex document feeder according to the present invention;

FIG. 9 is a perspective view of a conventional duplex document feeder;

FIG. 10 is an exploded view of a driver of the conventional duplex document feeder;

FIG. 11 is an exploded view of the driver of the conventional duplex document feeder seen from another angle;

FIG. 12 shows that a sheet is conveyed by the conventional duplex document feeder; and

FIG. 13 shows that the sheet is inverted by the conventional duplex document feeder.

### DETAILED DESCRIPTION OF THE PREFERRED EMBODIMENT

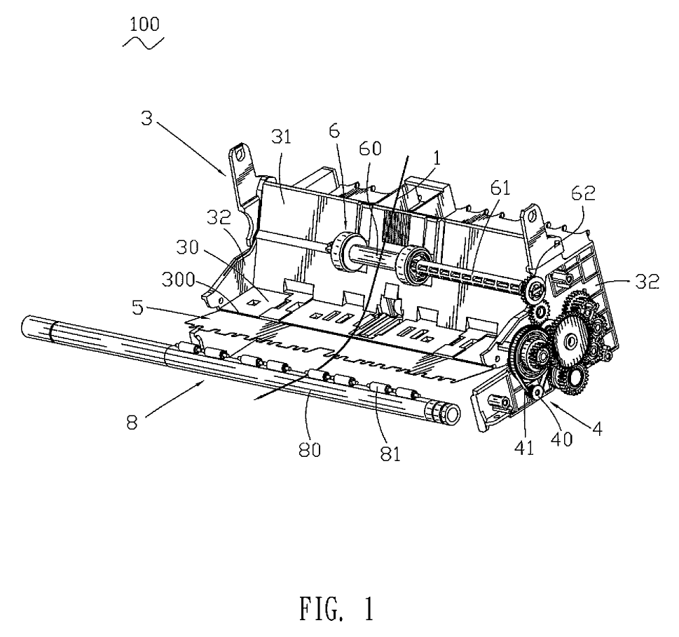

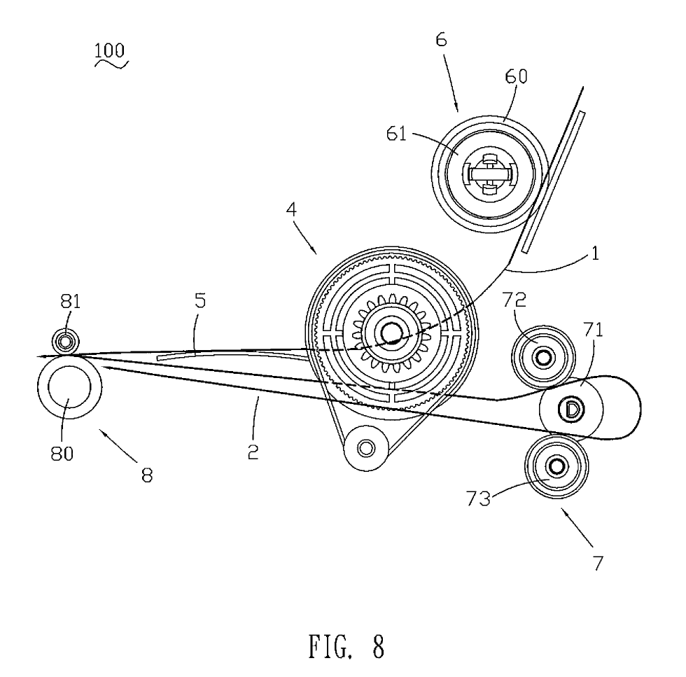

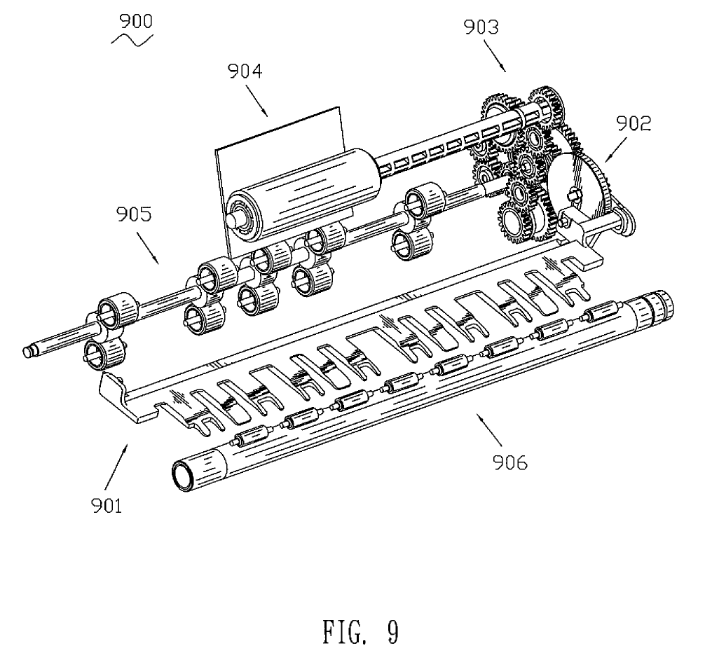

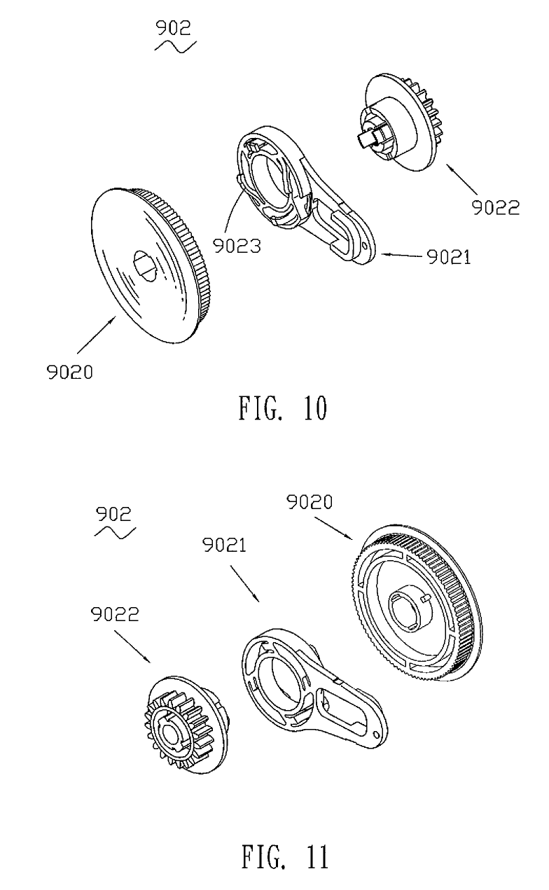

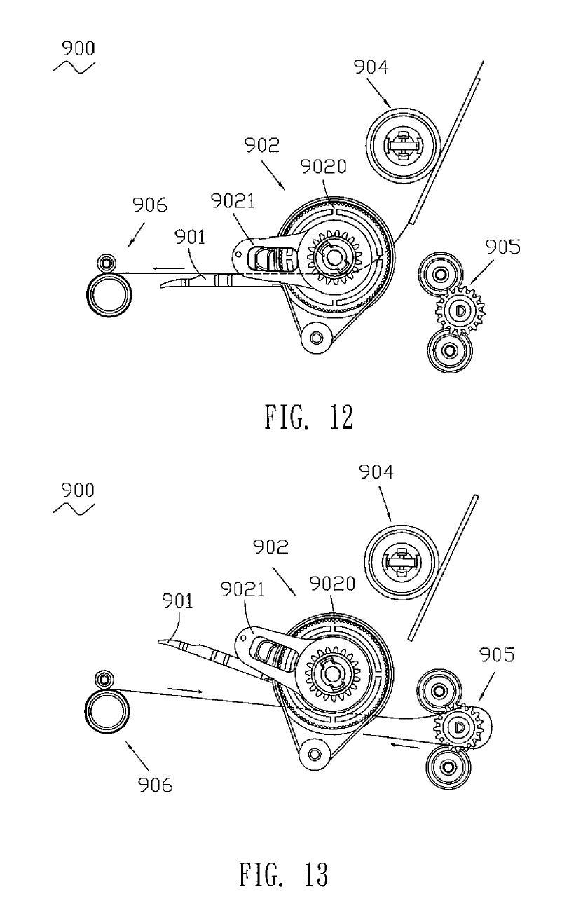

Please refer to FIG. 1 and FIG. 2. A preferred embodiment of a duplex document feeder 100 according to the present invention is shown. The duplex document feeder 100 defines a feeding path 1 and a sheet inverting path 2 communicated with the feeding path 1 (shown in FIG. 8) and has a frame 3, a driver means 4, a guiding plate 5, a charging means 6, a sheet inverting means 7 and a feeding means 8.

In this case, seen from one end to the other end of the feeding path 1, the charging means 6, the guiding plate 5 and the feeding means 8 are shown in turn. The sheet inverting path 2 forms as a cycle shape. In the sheet inverting path 2, the feeding means 8, the guiding plate 5 and the sheet inverting means 7 are shown in turn.

The frame 3 has a bottom plate 30, a front plate 31 obliquely extending upwards from the bottom plate 30, opposite side plates 32 connected to the bottom plate 30 and the front plate 31. In this case, the bottom plate 30 and the front plate 31 form an obtuse angle therebetween.

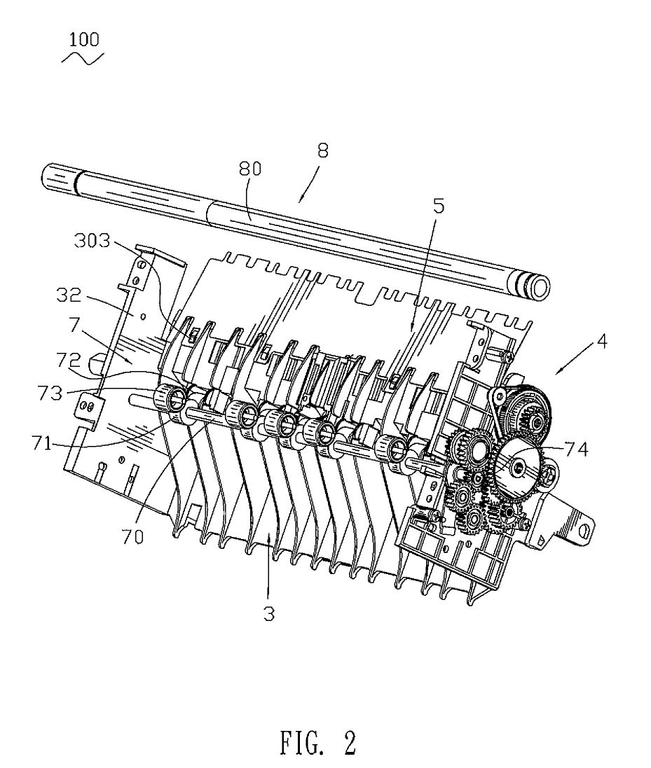

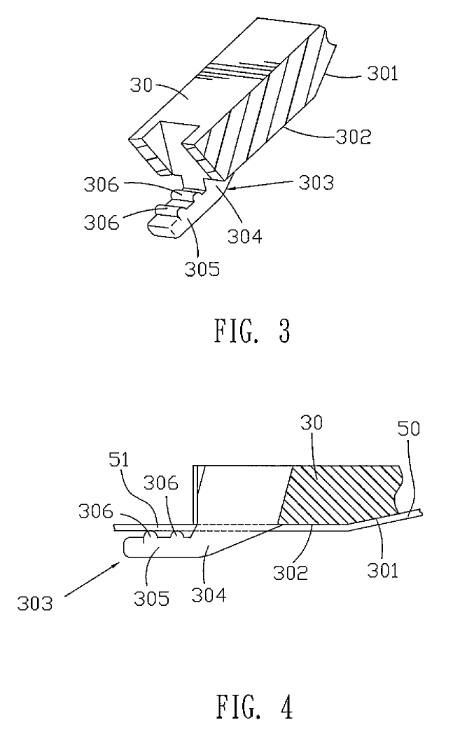

Please refer to FIG. 3 and FIG. 4. The bottom plate 30 defines a feeding edge 300 opposite to the feeding means 8. The bottom plate 30 forms an oblique surface 301 extending from the feeding edge 300 and a bottom surface 302 extending from the oblique surface 301. In this case, the oblique surface 301 extends downward and toward the sheet inverting means 7. The oblique surface 301 and the bottom surface 302 define an exterior angle which is an acute angle.

Plurality of engaging portions 303 are formed on the bottom surface 302 of the bottom plate 30 and close to the oblique surface 301. The engaging portion 303 has a connecting portion 304, an engaging arm 305, and at least one bulge 306. The connecting portion 304 is projected from the bottom surface 302 of the bottom plate 30. The engaging arm 305 extends from a lower portion of the connecting portion 303 and towards the sheet inverting means 7. The bulge 306 is projected from the top of the engaging arm 305 and towards the bottom surface 302 of the bottom plate 30.

Please refer to FIG. 1 and FIG. 2. The driver means 4 is configured to one of the side plates 32 of the frame 3. The driver means 4 has a pulse motor 40, an endless belt 41 and plurality of gears. The pulse motor 40 serves as the drive source capable of generating clockwise or anti-clockwise rotation. The endless belt 41 interconnects the pulse motor 40 and one of the gears. Therefore, the pulse motor 40 transmits rotation to the gears through the endless belt 41.

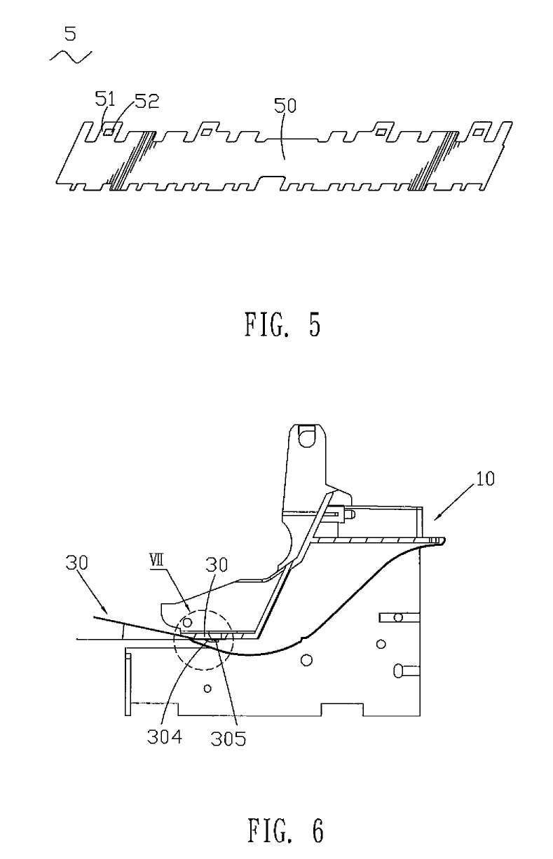

Please refer to FIG. 5. The guiding plate 5 is engaged with the engaging portion 303 of bottom plate 30 of the frame 3. The guiding plate 5 is an elastic plate. In this case, the guiding plate 5 is made of polyester. The guiding plate 5 has an oblique portion 50, at least one level portion 51 extending from the oblique portion 50 and at least one hole 52 opened through the level portion 51.

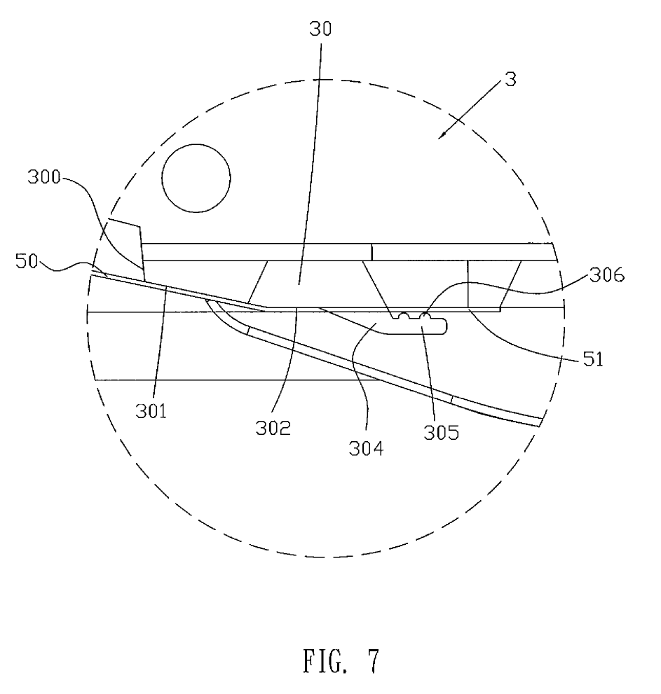

Please refer to FIG. 4 to FIG. 7. The guiding plate 5 is engaged with the bottom plate 3 of the frame 3 by engagement of the engaging portion 303 of the frame 3 and the level portion 51 and the hole 52 of the guiding plate 5. In this case, the level portion 51 of the guiding plate 5 is pressed between the engaging arm 305 of the engaging portion 303 and the bottom plate 30.

The connecting portion 304 of the engaging portion 303 passes through the hole 52 of the guiding plate 5. The bulge 306 of the engaging portion 303 is against the level portion 51 of the guiding plate 5. In this case, the oblique portion 50 of the guiding plate 5 attaches the oblique surface 301 of the bottom plate 30 and extends toward the feeding means 8 along the exterior angle defined by the oblique surface 301 and the bottom surface 302, the level portion 51 of the guiding plate 5 attaches the bottom surface 302 of the bottom plate 30.

Please refer to FIG. 1. The charging means 6 has a least one charging roller 60 arranged above the front plate 31 of the frame 3, a charging shaft 61 connected to the charging roller 60 and a charging gear 62 connected to one end of the charging shaft 61. The charging gear 62 meshes one of the gears of the driver means 4.

Please refer to FIG. 2. The sheet inverting means 7 is arranged behind the front plate 31 of the frame 3 and has an inverting shaft 70, plurality of first inverting rollers 71, plurality of second inverting rollers 72, plurality of third inverting rollers 73 and an inverting gear 74. The first inverting rollers 71 are separately connected to the inverting shaft 70.

Each first inverting roller 71 connects one of the second inverting rollers 72 and one of the third inverting rollers 73, wherein the second inverting rollers 72 and the third inverting rollers 73 are separated to each other. The inverting gear 74 is connected to one end of the inverting shaft 70 and meshed to one of the gears of the driver means 4.

Please refer to FIG. 1. The feeding means 8 is arranged opposite to the guiding plate 5. The feeding means 8 has a first feeding roller 80 and at least one second feeding roller 81. In this case, the first feeding roller 80 is formed as a shaft. The second feeding roller 81 is connected to the first feeding roller 80.

Please refer to FIG. 1 and FIG. 8. The operation of the duplex document feeder 100 is described afterward. While a sheet (not shown in figures) is conveyed into the feeding path 1, the pulse motor 40 of the driver means 4 drives the charging gear 62 of the charging means 6 to rotate in clockwise direction. The charging gear 62 transmits rotation to the charging roller 60 through the charging shaft 61. Therefore, the charging roller 60 rotates in clockwise direction. While the charging roller 60 still rotates in clockwise direction and connects the edge of the sheet, the charging roller 60 presses against the sheet and conveys the sheet into the feeding path 1.

The sheet is conveyed along the feeding path 1 and through the front plate 31 and the bottom plate 30 of the frame 3 and to the guiding plate 5. The sheet presses the guiding plate 5 via the conveying force formed by the charging means 6. Because the sheet presses the guiding plate 5 and the guiding plate 5 is the elastic plate, the guiding plate 5 is bent downwards. Therefore, the sheet can be conveyed through the guiding plate 5 and toward the feeding means 8.

The first and second feeding rollers 80, 81 extract the sheet form the feeding path 1. The guiding plate 5 returns to bounce upwards along the exterior angle defined by the oblique surface 301 and the bottom surface 302 of the bottom plate 30 of the frame 3 while the sheet is depart from the charging means 6 and is stop pressing the guiding plate 5.

While the feeding means 8 conveys the sheet to the sheet inverting path 2, the pulse motor 40 of the driver means 4 drives the charging roller 60 of the charging means 6 to rotate in anti-clockwise direction. The other sheets located outside the feeding path 1 are therefore blocked from being fed into feeding path 1 by the charging roller 60 of the charging means 6. The guiding plate 5 is still in a bounce status and the sheet may he conveyed through the guiding plate 5 and to the sheet inverting means 7.

In this case, the pulse motor 40 of the driver means 4 drives the inverting gear 74 of the sheet inverting means 7 to rotate in clockwise direction. The sheet is conveyed into the sheet inverting means 7 and between the first inverting roller 71 and the second inverting roller 72. Then, the sheet is guided to be inverted and conveyed between the first inverting roller 71 and the third inverting roller 73. Then, the sheet inverting means 7 conveys the sheet to the feeding means 8. Therefore, the feeding means 8 extracts the sheet form the sheet inverting path 2.

As described aforesaid, the guiding plate 5 has a function as a switch arranged between the feeding path 1 and the sheet inverting path 2. While the sheet is not fed into the feeding path 1, the guiding plate 5 is as a switch and blocked up the feeding path 1. The guiding plate 5 is pressed by the sheet and then bent downwards. Therefore, the guiding plate 5 is shift out of the feeding path 1.

So, the sheet may be conveyed through the feeding path 1 and to the sheet inverting path 2. While the sheet is conveyed into the sheet inverting path 2, the guiding plate 5 returns to bounce upwards and block up the feeding path 1. So, the sheet may be conveyed through the sheet inverted path 2 Therefore, the duplex document feeder 100 has a simple structure for guiding the sheet to pass through the feeding path and the sheet inverting path.

Furthermore, the present invention is not limited to the embodiments described above; various additions, alterations and the like may be made within the scope of the present invention by a person skilled in the art. For example, respective embodiments may be appropriately combined.

What is claimed is:

1. A duplex document feeder, comprising:
A frame having a bottom plate formed a feeding edge, an oblique surface obliquely extending downwards from said feeding edge and a bottom plate extending from said oblique surface, said oblique surface and said bottom surface defining an exterior angle which is an acute angle;
a charging means charging documents into said duplex document feeder;
a feeding means arranged opposite to said feeding edge of said bottom of said frame for discharging said documents from said duplex document feeder;
a sheet inverting means inverting said documents and conveying said documents to said feeding means;
a driver means providing drive source to said charging means and said sheet inverting means; and
a guiding plate equipped elastic force, said guiding plate attached to said bottom surface and said oblique surface of said bottom plate of said frame and extending upwards along said oblique surface of said bottom plate of said frame.

2. The duplex document feeder as claimed in claim 1, wherein said frame has a front plate formed from said bottom plate and extending upwardly to form as an obtuse angle therebetween and opposite side plates connected to said bottom plate and said front plate, said sheeting inverting means is arranged behind said front plate of said frame, said driver means configured to one of said side plates of said frame.

3. The duplex document feeder as claimed in claim 2, wherein said driver means has a motor; plurality of gears and an endless belt interconnected said motor and one of said gears.

4. The duplex document feeder as claimed in claim 3, wherein said charging means has a charging roller arranged above said front plate of said frame, a charging shaft connected to said charging roller and a charging gear connected to one end of said charging shaft and meshed to one of said gears of said driver means.

5. The duplex document feeder as claimed in claim 3, wherein said sheet inverting means has a inverting shaft, plurality of first inverting rollers, plurality of second inverting rollers, plurality of third inverting rollers and an inverting gear, said first inverting rollers are separately connected to said inverting shaft, each first inverting roller is connected to one of said second inverting rollers and one of said third inverting rollers, said second inverting rollers and said third inverting rollers are separated to each other, said inverting gear is connected to one end of said inverting shaft and meshed to one of said gears of said driver means.

6. The duplex document feeder as claimed in claim 1, wherein said bottom surface of said bottom plate defines plurality of engaging portions close to said oblique surface, said engaging portion has a connecting portion projected from said bottom surface of said bottom plate, an engaging arm extending from a lower portion of said connecting portion, and at least one bulge projected from the top of said engaging arm and towards the bottom surface of said bottom plate.

7. The duplex document feeder as claimed in claim 1, wherein said guiding plate is made of polyester.

8. The duplex document feeder as claimed in claim 6, wherein said guiding plate has an oblique portion, at least one level portion extending from said oblique portion and at least one hole opened through said level portion, said level portion of said guiding plate is pressed between said engaging arm of said engaging portion and said bottom surface of said bottom plate of said frame, said connecting portion of engaging portion of said frame passes through said hole of said guiding plate, said bulge of said engaging portion of said frame is against said level portion of said guiding plate.

9. A duplex document feeder defining a feeding path, comprising:
a charging means for charging documents into said feeding path;
a guiding plate equipped with elastic force and blocked up said feeding path; and
a feeding means discharging said documents form said feeding path, wherein one end to the other end of said feeding path, said charging means, said guiding plate and said feeding means are arranged in turn, said guiding plate is pressed via said document which is conveyed by said charging means and bent for being shifted out of said feeding path to permit said documents being conveyed to said feeding means, and said guiding plate returns to block up said feeding path by its elastic force while said document is conveyed from said charging means.

10. The duplex document feeder as claimed in claim 9, wherein said charging means is provided drive source to rotate in clockwise and anti-clockwise from a driver means, which has a charging roller for pressing against said documents and transferring said documents and a charging gear engaging with said driver means for receiving said drive source and transferring said drive source to said charging roller through a shaft interconnected therebetween.

11. The duplex document feeder as claimed in claim 10, wherein said driver means has a motor for providing said drive source, plurality of gears for transferring said drive source from said motor to said charging means and a endless belt interconnected between said motor and said gears for transferring said drive source from said motor to said gears.

12. The duplex document feeder as claimed in claim 11, wherein said motor is a pulse motor.

13. The duplex document feeder as claimed in claim 9, further comprising a sheeting inverting path communicated with said feeding path, said sheet inverting path formed as a cycle shape, seen from said sheet inverting path, said feeding means, said guiding plate and a sheeting inverting means being arranged in turn, said sheet inverting means receiving said documents form said feeding means and inverting said documents and then transferring said documents to said feeding means.

14. The duplex document feeder as claimed in claim 13, wherein said sheet inverting means has a inverting shaft, a first inverting roller connected to said inverting shaft, a second inverting roller connected to said first inverting roller, a third inverting roller connected to said first inverting roller and a inverting gear engaged with said driver means for receiving said drive source and transferring said drive source to said first inverting roller through said inverting shaft, said first and second inverting rollers receives said document transferred from said feeding means in a first direction, said first and third inverting rollers receiving said document from said document from said first and second inverting rollers and transferring said document to said feeding means in a second direction opposite to said first direction.
